(19) United States
(12) Patent Application Publication
(10) Pub. No.: US 2012/0278495 A1
(43) Pub. Date: Nov. 1, 2012

(54) REPRESENTATION GROUPING FOR HTTP STREAMING

(75) Inventor: David Stuart Furbeck, Keller, TX (US)

(73) Assignee: RESEARCH IN MOTION LIMITED, Waterloo (CA)

(21) Appl. No.: 13/094,246

(22) Filed: Apr. 26, 2011

(51) Int. Cl. G06F 15/16

(52) U.S. Cl. 709/231

(57) ABSTRACT

A method to stream media content via hypertext transfer protocol that includes receiving, at a client device, metadata including an attribute indicating a grouping of representations of the media content where each representation of the grouping of representations comprises a respective encoding choice of the media content.

### BACKGROUND

1. Technical Field

The present disclosure relates generally to hypertext transfer protocol (HTTP) streaming of media content and, more particularly, to the grouping of representations of media content.

2. Related Art

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The 3^{rd} Generation Partnership Project (3GPP) has developed a feature known as HTTP Streaming, whereby mobile telephones, personal digital assistants, handheld or laptop computers, desktop computers, set-top boxes, network appliances, and similar devices can receive streaming media content via the hypertext transfer protocol (HTTP). Any device that can receive HTTP Streaming data will be referred to herein as a client (or client device). Content that might be provided to such client devices via HTTP can include streaming video, streaming audio, and other multimedia content such as timed text. In some cases, the content is prepared and then stored on a standard web server for later streaming via HTTP. In other cases, live or nearly live streaming might be used, whereby content is placed on a web server at or near the time the content is created. In either case, clients can use standard web browsing technology to receive the streamed content at any desired time.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a system architecture for adaptive HTTP streaming in accordance to the present disclosure;

FIG. 2 is a table illustrating an exemplary grouping of representation of media content in accordance with the present disclosure;

FIG. 3 is an excerpt of XML schema of an MPD that describes an exemplary representation in accordance with the present disclosure; and

FIG. 4 illustrates a processor and related components suitable for implementing the implementations of the present disclosure.

### DETAILED DESCRIPTION

It should be understood at the outset that although illustrative implementations of one or more embodiments of the present disclosure are provided below, the disclosed devices, systems and/or methods may be implemented using any number of techniques, whether currently known or in existence. The components in the figures are not necessarily to scale, emphasis instead being placed upon illustrating the principles of the disclosed technology. Moreover, in the figures, like referenced numerals designate corresponding parts or elements throughout the different views. The following description is merely exemplary in nature and is in no way intended to limit the disclosure, its application, or uses. As used herein, the term “module” refers to an Application Specific Integrated Circuit (ASIC), an electronic circuit, a processor (shared, dedicated, or group) and memory that executes one or more software or firmware programs stored in the memory, a combinational logical circuit, and/or other suitable components that provide the described functionality. Herein, the phrase “coupled with” is defined to mean directly connected to or indirectly connected through one or more intermediate components. Such intermediate components may include both hardware and software based components.

As noted in the background, client devices, also referred to herein as clients, may receive streaming media content via the hypertext transfer protocol (HTTP) utilizing a feature known as HTTP Streaming. Media content provided to a client by, for example, a standard HTTP server may include various media components such as streaming video, streaming audio, and/or other multimedia content (e.g., timed text). Each media component, or alternatively, the entire set of media components for a given media presentation may be offered in several alternative choices or formats that differ by encoding choice. For example, the alternative choices (i.e., encodings) of the media content or subsets of the media content may differ by bit rate, resolution, language, and/or codec.

By way of introduction, the apparatuses and/or methods described herein are related to adaptive HTTP streaming of media content to a client. The present disclosure describes a categorization, or assignment scheme of grouping alternative choices of the media content or subsets of the media content of a given media presentation, thereby improving the efficiency in which a client is informed of the alternative choices of media content available for a given media presentation.

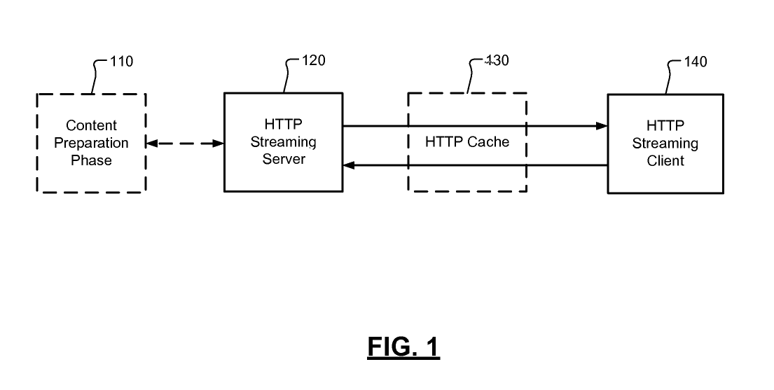

Referring to FIG. 1, an exemplary system architecture for adaptive HTTP streaming that implements the apparatuses and method of the present disclosure is shown. The system architecture includes a content preparation phase 110, an HTTP streaming server 120 (or simply server 120), an HTTP cache 130, and the HTTP streaming client 140 (or simply client 140). The content preparation phase 110 prepares a media presentation for HTTP streaming. The media content of the media presentation is stored on an HTTP streaming server 120 and/or in the HTTP cache 130. A media presentation is a structured collection of data that is accessible to the client 140. The client 140 requests and downloads media data information to present a streaming service to a user of the client 140.

The client 140 may utilize an HTTP GET request or a similar message to request and download the media presentation from the HTTP streaming server 120 and/or the HTTP cache 130. In other words, the HTTP streaming server 120 and/or the HTTP cache 130 provide the media presentation to the client 140 based on the receipt of a request. The client 140 may then present the media presentation to a user.

The media presentation may be described in an extensible markup language (XML) document, which in the 3GPP specifications is called a Media Presentation Description (MPD). The MPD contains metadata informing the client of the various formats in which the media content of the media presentation maybe encoded. In some implementation, the MPD may be provided (i.e., delivered or streamed) to the client from a server such as server 120. As mentioned above, each format of the media content may be encoded with a distinct bit rate, resolution, language, and/or codec. These various formats of the media content (i.e., the media presentation) are referred to as “representations.” In other words, each representation constitutes one encoding choice among a possible plurality of encoding choices of the media content or a subset of the media content. The MPD contains a description of each available representation of the media presentation. During operation (i.e., during a streaming session), the client 140 is guided by the information in the MPD, namely, the client 140 may select one or more representations of the of the media presentation based on the information provided in the MPD as well as other information related to channel conditions (e.g., available bandwidth). In addition, the client 140 may select one or more representations of the of the media presentation based on capabilities or constraints of the client 140. For example, the client 140 may select a particular representation (or representations) of the media presentation based on screen resolution, the current channel bandwidth, the current channel reception conditions, the language preference of the user, and/or other parameters.

A given media presentation includes a sequence of one or more periods. Each period is indicative of a distinct period of time (i.e., time line) of the given media presentation. A time line of a media presentation is defined by the concatenation of the respective time line of each constituent period. As such, periods within a given media presentation are sequential and generally non-overlapping. In other words, each period extends until the start of the next period within the media presentation. Each period of a given media presentation contains one or more representations of the same media content. In other words, each period contains one or more formats of the media content encoded with a distinct bit rate, resolution, language, and/or codec, etc. Furthermore, the timeline of each period is common amongst all representations within that period. The grouping scheme of various representations of the media content or subsets of the media content of a given media presentation will be discussed in more detail below.

An MPD describing an entire media presentation may be provided to the client 140, and the client 140 may use the metadata in the MPD throughout the media presentation (i.e., throughout the duration of the time line of the media presentation). In live streaming scenarios, the metadata describing an entire media stream may not be known prior to commencement of a streaming session. Furthermore, parameters (e.g., channel conditions) related to the streaming session may change during the course of the session. For example, a client may move into an area with poor reception, and the data rate may slow down. In such a case, the client may need to switch to a representation with a lower bit rate. In another example, a client may choose to switch the display of the streamed media content from portrait to landscape mode, in which case a different representation may be required.

As such, in accordance with 3GPP HTTP Adaptive Streaming, each representation includes one or more downloadable portions of media and/or metadata referred to as segments whose locations are indicated in the MPD. With HTTP Streaming, the media content may be downloaded one segment at a time so that play-out of live content does not fall too far behind live encoding and so that a client can switch to a different content encoding adaptively according to channel conditions or other factors, as described above. A segment is defined as a unit (i.e., a portion) that is uniquely referenced by a hypertext transfer protocol-uniform resource locator (HTTP-URL) or a combination of the HTTP-URL and a byte range included in the MPD. In other words, segments are addressable by a client based on the information in metadata.

Furthermore, each representation either contains an initialisation segment or each media segment within the given representation is self-initialising. The initialization segment contains information for accessing the given representation and typically does not contain any media data. In other words, the initialization segment provides a client with metadata that describes the associated media content. In the present implementation, the initialisation segment includes a “ftyp” (i.e., a file-type) box, a “moov” (i.e., a movie) box, and optionally a “pdin” box as described in the ISO/IEC 14496-12 ISO Base Media File Format.

A representation contains one or more media components where each media component is an encoded version of a respective media type such as audio, video, or timed text. Media components are time-continuous across boundaries of consecutive media segments within a given representation. A media segment contains media components that are either described within the media segment or described by an initialisation segment of the given representation. In the present implementation, each media segment of a given representation contains one or more whole, self-contained movie fragments. A whole, self-contained movie fragment includes a “moof” (i.e., a movie fragment) box and a “mdat” (i.e., media data) box. The mdat box contains the media samples that are referenced by track runs in the respective movie fragment. The moof box contains the metadata for the respective movie fragment.

Referring back to FIG. 1, the streaming client 140 may use of the 3GPP file format and movie fragments. The 3GPP file format is based on the ISO/IEC 14496-12 ISO Base Media File Format. Media files, in accordance with the ISO Base Media File Format, comprise of a series of objects called boxes. Boxes can contain media data or metadata. In non-fragmented files, the moov box contains the codec information, timing information, and location information needed to play the media data. For fragmented media files provided via HTTP Adaptive Streaming, the moov box simply contains codec information, and the timing information and location information is contained within the movie fragments (i.e., within one or more media segments) themselves. The use of fragmented files enables an encoder (not shown) to write and a client to receive the media one portion at a time. This minimizes startup delay by including metadata in the moof boxes of the media fragments as opposed to up front in the moov box. In HTTP Adaptive Streaming, the moov box may contains a description of the codecs used for encoding, but typically does not contain any specific information about the media samples such as timing, offsets, etc. Moof boxes contain references to the codecs listed in the moov box.

As mentioned above, a representation contains one or more media components where each media component is an encoded version of a respective media type such as audio, video, or timed text. In some instances, it may be beneficial for purposes of efficiency of streaming service to store various media components of a given media presentation separately on the server 120 such that the media components are streamed separately from the server 120. In this configuration, each of the media components constitutes a distinct representation. In this manner, client 140 may selectively choose which media component(s) the client 140 wishes to download (i.e., stream over HTTP) and which media component(s) the client 140 does not wish to download from the server 120. For example, if channel conditions affecting the streaming session between the client 140 and the server 120 deteriorate, the client 140 may elect to receive an audio component of a media presentation and refrain from receiving a video component of the media presentation which typically requires significant channel bandwidth. If each media component (e.g., audio and video components) is stored in the same file (i.e., not stored separately) at the server 120, the client 140 is limited to only receiving both audio and video components or neither regardless of channel conditions or any other operating conditions affecting the streaming session, thereby potentially resulting in a poor user experience. However, by storing each of the media components separately (i.e., in respective files) at the server 120, in the present example, the client 140 is required to provide multiple requests (e.g., HTTP GET requests) to separately retrieve the audio and video segments of the media presentation from the server 120. In contrast, if all the constituent media components for a particular representation are stored in a single file at the server 120, the client 140 only needs to provide a single request to retrieve the selected content.

The apparatuses and methods of the present disclosure provide a flexible manner with which to efficiently indicate to a client (e.g., client 140) how various representations of the media content are intended to be consumed (i.e., separately or in combination). As a result, the ways in which media components are stored (e.g., in separate files or in a common file) at a server can be left to the discretion of a content provider providing the media content. More particularly, the present disclosure describes a grouping or assignment scheme that indicates whether a given representation is an alternative choice of media content or whether the representation is alternative choice within a subset of the media content. In other words, the present disclosure describes a parameter, element, or other data (e.g., a “group attribute” in the present implementation) in metadata, sent by a server, that informs a client that a given representation includes an alternative encoding of every media component (e.g., audio, video, and time text) of the media content or that the representation simply constitutes an alternative encoding of a single media component (i.e., a subset) of the media content and may be combined with other representations.

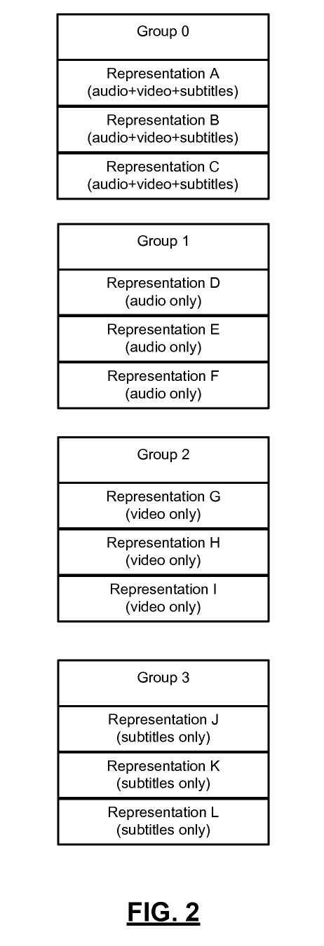

Referring now to FIG. 2, an exemplary grouping of representations within a given period is shown. For the sake of simplicity and brevity, the present disclosure will discusses the various groupings of various encodings of audio, video, and/or time text media types. Although the present embodiment depicts four groups (also referred to herein as “groupings”) each having three constituent representations, that a variable number of groups each having a variable number of representations is contemplated. Furthermore, those skilled in the art will appreciate that the group attributes (e.g., “0”, “1”, “2”, and “3”) referencing the respective groups have been arbitrarily assigned.

As depicted in FIG. 2, the exemplary representations are assigned to one of “Group 0”, “Group 1”, “Group 2”, and “Group 3” (i.e., each exemplary representation is assigned to a group (or grouping) having a respective group attribute). In other words, each representation within a given group is associated with, characterized by, or identified by a common group attribute provided in metadata. In some implementations, each representation within a given group may be associated with or defined by a “parent element” (not shown). In these implementations, the group attribute (discussed above) would be attributed to or assigned to the parent element.

Representations within a respective group are alternatives to each other (i.e., each representation has a distinct encoding of a common set of media types(s)) of the media content available within a given period). For example, “Representation A”, “Representation B” and “Representation C” of Group 0 each represent a unique, alternative encoding of a combination of audio, video, and subtitle components for the media content of the given period. Whereas “Representation G”, “Representation H” and “Representation I” of Group 2 each represent a unique, alternative encoding of only the video component for the media content of the given period. In the present implementation, each representation within Group 0 represents a “complete” representation such that that each representation contains all the media components available for the media content during that period. In other words, the representations of Group 0 need not be combined by the client 140 with any other representation in order to deliver all the available media content for that period. As such, representations assigned to Group 0 are presented without any other representations from another group (i.e., any non-zero group).

In contrast, in the present implementation, the respective representations within Group 1, Group 2, and Group 3 (i.e., the groups having a non-zero group attribute) represent “non-complete” alternative encodings within a respective subset (e.g., audio only, video only, subtitles only) of the media content for the given period. Since representations from Groups 1, 2, and 3 only provide an alternative encoding for a particular subset of the media content, each of these representations is considered “non-complete.” As such, representations assigned to a non-zero group may be presented in combination with representations from other non-zero groups (i.e., not including Group j). Therefore, in order for the client 140 to stream all the media content for the given period, the client 140 selects/requests at most one representation from each non-zero group. For example, during an exemplary streaming session, the client 140 may select a combination of Representation F from Group 1, Representation G from Group 2, and Representation K from Group 3 in order to stream all the media content for the given period of the media presentation. As such, in FIG. 2, the media content during a given period is represented by either one representation from Group 0, since the representation is present (i.e., available), or a combination of at most one representation from each non-zero group.

In the present implementation, the client 140 may select one representation assigned to Group 0 or the client 140 may select multiple representations, at most one from each non-zero group (e.g., Group 1, Group 2, and Group 3 based on information provided in the metadata and/or other information such as the bandwidth available during the streaming session and/one or more capabilities of the client 140. Once a media presentation has begun streaming from the server 120 to the client 140 based on the selected representation(s), the client 140 continuously consumes media content by requesting media segments or parts of media segments of the respective representations. As previously mentioned, a client may elect to switch to different representation(s) during the course of the streaming session taking in to account (i.e., consideration) any updated MPD information the client may have received from the server 120 and/or any updated information characterizing an environment of the device 140 (e.g., a change in the available bandwidth). In other words, the client 140 may begin streaming segments from a representation or a set of representations that differ from that representation or set of representations utilized prior to the switch. In one example, the client 140 may elect to switch from Representation A to Representation C within Group 0. In another example, the client 140 may elect to switch from Representation D of Group 1, Representation H of Group 2, and Representation L of Group 3 to Representation F of Group 1, Representation G of Group 2, and Representation J of Group 3. In yet another example, the client 140 may elect to switch from Representation B of Group 0 to Representation D of Group 1 and Representation G of Group 2 (i.e., the client 140 may wish not to further receive the subtitles media component).

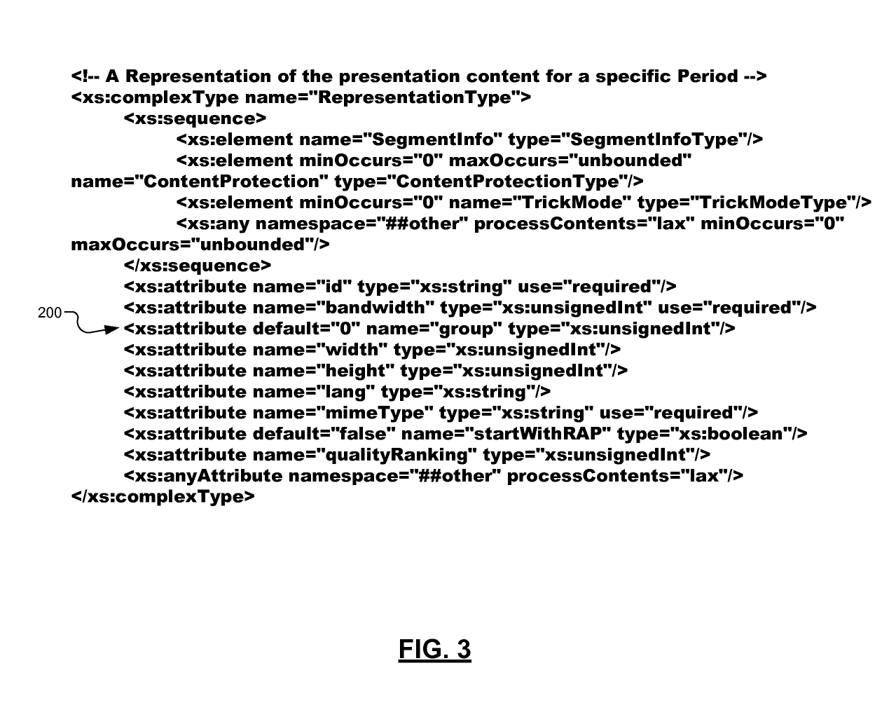

Referring now to FIG. 3, an excerpt of XML schema of an MPD that describes an exemplary representation is illustrated. Within the description of the representation, at 200, is a description of the group attribute for the exemplary representation.

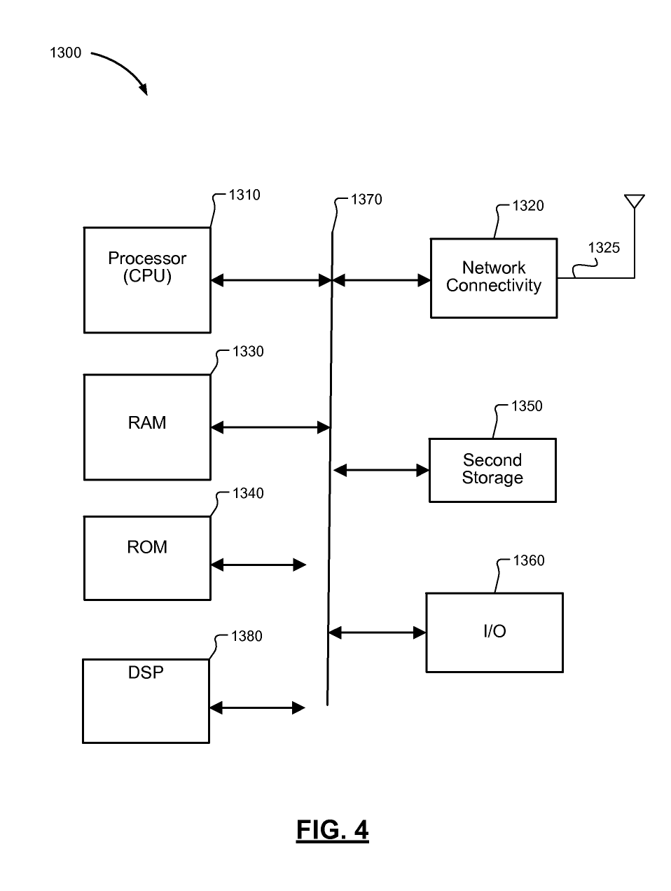

The content preparation phase 110, the HTTP streaming server 120, the HTTP cache 130, and the HTTP streaming client 140 described above may include a processing component that is capable of executing instructions related to the actions described above. FIG. 4 illustrates an example of a system 1300 that includes a processing component, processor 1310, suitable for implementing one or more implementations disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components (also referred to herein as modules) might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1380. Although the DSP 1380 is shown as a separate component, the DSP 1380 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information. The network connectivity devices 1320 might also include one or more transceiver components 1325 capable of transmitting and/or receiving data wirelessly.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1325 might be considered to be a component of the I/O devices 1360 instead of or in addition to being a component of the network connectivity devices 1320.

The following are incorporated herein by reference for all purposes: 3GPP Technical Specification (TS) 26.234, 3GPP TS 26.244, ISO/IEC 14496-12, Internet Engineering Task Force (IETF) Request for Comments (RFC) 5874, and IETF RFC 5261.

All of the discussion above, regardless of the particular implementation being described, is exemplary in nature, rather than limiting. Although specific components of the present disclosure are described, methods, systems, and articles of manufacture consistent with the present disclosure may include additional or different components. For example, components of present disclosure may be implemented by one or more of: control logic, hardware, a microprocessor, microcontroller, application specific integrated circuit (ASIC), discrete logic, or a combination of circuits and/or logic. Further, although selected aspects, features, or components of the implementations are depicted as hardware or software, all or part of the apparatuses and methods consistent with the present disclosure may be stored on, distributed across, or read from machine-readable media, for example, secondary storage devices such as hard disks, floppy disks, and CD-ROMs; a signal received from a network; or other forms of ROM or RAM either currently known or later developed. Any act or combination of acts may be stored as instructions in computer readable storage medium. Memories may be DRAM, SRAM, Flash or any other type of memory. Programs may be parts of a single program, separate programs, or distributed across several memories and processors.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs and rule sets may be parts of a single program or rule set, separate programs or rule sets, or distributed across several memories and processors.

It is intended that the foregoing detailed description be understood as an illustration of selected forms that the invention can take and not as a definition of the invention. It is only the following claims, including all equivalents, that are intended to define the scope of this disclosure.

1. A method related to streaming media content via hypertext transfer protocol, comprising:
receiving, at a client device, metadata including group information indicating a grouping of representations of the media content,
wherein each representation of the group of representations comprises a respective encoding choice of the media content.

2. The method of claim 1 further comprising requesting one representation of the grouping of representations.

3. The method of claim 2 wherein the one representation is requested based on a channel condition.

4. The method of claim 2 further comprising switching from requesting the one representation to requesting another representation of the grouping of representations based on a change in a channel condition.

5. The method of claim 1 wherein each representation of the grouping of representations is an alternative to one another.

6. The method of claim 1 wherein a value of the group information indicates that the representations are not presented with other representations.

7. The method of claim 1 wherein a value of the group information indicates that the representations are combinable with other representations from other groupings.

8. The method of claim 2 wherein the group information indicates that the grouping of representations is one of a plurality of groupings of representations.

9. The method of claim 8 further comprising requesting a plurality of representations from the plurality of groupings of representations.

10. The method of claim 9 further comprising switching from requesting the plurality of representations to requesting another plurality of representations from the plurality of groupings based on a change in a channel condition.

11. A device to stream media content via hypertext transfer protocol, comprising:
a processor configured to:
receive metadata including group information indicating a grouping of representations of the media content,
wherein each representation of the grouping of representations comprises a respective encoding choice of the media content.

12. The device of claim 11 wherein the processor is further configured to request one representation of the grouping of representations.

13. The device of claim 12 wherein the processor is further configured to request the one representation based on a channel condition.

14. The device of claim 12 wherein the processor is further configured to switch from requesting the one representation to requesting another representation of the grouping of representations based on a change in a channel condition.

15. The device of claim 11 wherein the processor is further configured to receive the metadata with each representation of the group of representations being an alternative to one another.

16. The device of claim 11 wherein the processor is further configured to receive the group information with a value of the group information indicating that the representations are not presented with other representations.

17. The device of claim 11 wherein the processor is further configured to receive the group information with a value of the group information indicating that the representations are combinable with other representations from other groupings.

18. The device of claim 12 wherein the processor is further configured to receive the group information with the group information indicating that the grouping of representations is one of a plurality of groupings of representations.

19. The device of claim 18 wherein the processor is further configured to request a plurality of representations from the plurality of groupings of representations.

20. The device of claim 19 wherein the processor is further configured to switch from requesting the plurality of representations to requesting another plurality of representations from the plurality of groupings based on a change in a channel condition.

21. A network device to stream media content via hypertext transfer protocol, comprising:
a processor configured to:
provide metadata including group information indicating a grouping of representations of the media content,
wherein each representation of the grouping of representations comprises a respective encoding choice of the media content.

22. The device of claim 21 wherein the processor is further configured to receive a request for one representation of the grouping of representations.

23. The device of claim 21 wherein the group information is a group attribute.

24. The device of claim 22 wherein the processor is further configured to switch from providing the one representation to providing another representation of the grouping of representations.

25. The device of claim 21 wherein the processor is further configured to provide the metadata with each representation of the group of representations being an alternative to one another.

26. The device of claim 21 wherein the processor is configured to provide the group information with a value of the group information indicating that the representations are not presented with other representations.

27. The device of claim 21 wherein the processor is configured to provide the group information with a value of the group information indicating that the representations are combinable with other representations from other groupings.

28. The device of claim 22 wherein the processor is further configured to provide the group information that indicates that the grouping of representations is one of a plurality of groupings of representations.

29. The device of claim 28 wherein the processor is further configured to provide a plurality of representations from the plurality of groupings of representations.

30. The device of claim 29 wherein the processor is further configured to switch from providing the plurality of representations to providing another plurality of representations from the plurality of groupings.

31. A method related to streaming media content via hypertext transfer protocol, comprising:
providing metadata including group information indicating a grouping of representations of the media content,
wherein each representation of the grouping of representations comprises a respective encoding choice of the media content.

32. The method of claim 31 further comprising receiving a request for one representation of the grouping of representations.

33. The method of claim 31 wherein the group information is a group attribute.

34. The method of claim 32 further comprising switching from providing the one representation to providing another representation of the grouping of representations.

35. The method of claim 31 wherein each representation of the group of representations is an alternative to one another.

36. The method of claim 31 wherein a value of the group information indicates that the representations are not presented with other representations.

37. The method of claim 31 wherein a value of the group information indicates that the representations are combinable with other representations from other groupings.

38. The method of claim 32 wherein the grouping of representations is one of a plurality of groupings of representations.

39. The method of claim 38 further comprising providing a plurality of representations from the plurality of groupings of representations.

40. The method of claim 39 further comprising switching from providing the plurality of representations to providing another plurality of representations from the plurality of groupings.

41. The method of claim 1 wherein the group information is a group attribute.

42. The device of claim 11 wherein the group information is a group attribute.

43. The method of claim 2 wherein the one representation is requested based on a capability of the client device.

44. The device of claim 12 wherein the processor is further configured to request the one representation based on a capability of the device.
